(19) United States
(12) Patent Application Publication
(10) Pub. No.: US 2005/0066560 A1
(43) Pub. Date: Mar. 31, 2005

(54) Display board assembly

(75) Inventors: Scott Ternovits, Chicago, IL (US); Andrew Manocheo, Chicago, IL (US)

Correspondence Address: MICHAEL BEST & FRIEDRICH, LLP, 100 E WISCONSIN AVENUE, MILWAUKEE, WI, 53202, US

(73) Assignee: ACCO Brands, Inc., Lincolnshire, IL (US)

(21) Appl. No.: 10/675,032

(22) Filed: Sep. 30, 2003

(51) Int. Cl. G09F 15/00; G09F 7/02

(52) U.S. Cl. 40/606.19; 40/611.06

(57) ABSTRACT

A display board assembly comprising a display board and a frame coupled to the display board. The frame defines a gap dimensioned to receive and hold a sheet. The frame may include a body engageable with the display board. The body may further include a first projection defining a first surface and a second projection defining a second surface positioned to face the first surface, wherein the first and second surfaces define the gap dimensioned to receive and hold a sheet. The body can define a longitudinal direction and a transverse direction substantially perpendicular to the longitudinal direction. The display board assembly can be used to post a sheet by inserting a sheet into the gap substantially along the transverse direction.

### BACKGROUND OF THE INVENTION

The present invention generally relates to the field of message display boards and, more specifically, to message display boards that are capable of holding sheets of paper.

Existing display board assemblies often allow sheet-like items to be posted on or adjacent the display board. For example, such items can be posted using pushpins, magnets, paper clips, adhesive sticky-notes, adhesive tape, and the like. Existing display board assemblies can include more than one type of display such that a message or sketch can be written or drawn on a writable surface near where other messages or pictures are posted. Other posting devices include clips, clamps, or other spring-mounted moving parts for posting messages.

The display board assemblies that require the use of pushpins or adhesive tape often destroy photographs or other display items, such as cards, messages, notes, and the like, that a user posts on the display board assembly. Additionally, existing posting devices for use with display board assemblies (i.e., pushpins, paper clips, adhesive tape, magnets, and the like) often cover up or conceal a portion of the display item. In addition, existing posting devices are often positioned or used such that the display item covers up or conceals a portion of the display board. Furthermore, posting messages on or adjacent a display board assembly can add unattractive clutter to the overall appearance of the display board assembly and its environment. Moreover, posting devices used with display board assemblies that require other components, such as magnets, paperclips, pushpins, adhesive tape, and the like can become cumbersome and cluttered, and the posting components can be lost, thereby rendering the posting device ineffective. Posting devices that include clips, clamps, or otherwise include moving parts or devices can wear out over time, or permanently mar or damage the photo, card, message, or the like.

It is also possible to slide sheet-like items between a picture frame and the item being displayed. For example, a note can be inserted into the space between the interior edge of the frame and a transparent material covering the displayed item. However, the thickness of the sheet-like item being inserted is limited to the small space between the frame and the transparent material. In addition, positioning the sheet-like item in the described manner results in portions of the displayed item being obscured.

### SUMMARY OF THE INVENTION

The present invention is generally directed to a display board assembly comprising a display board and a frame coupled to the display board. The frame defines a gap dimensioned to receive and hold a sheet. The frame may comprise a body having a first projection defining a first surface and a second projection defining a second surface positioned to face the first surface. The first and second surfaces define the gap dimensioned to receive and hold the sheet.

By virtue of this design, the sheet can be held in place without the need for moving devices. In addition, there is a lower likelihood of damaging the sheet, compared to prior art designs. In addition, when the gap is formed on the outer perimeter of the frame, the sheet will not obscure the display board, thus increasing the useful surface area of the display board.

Other features and aspects of the invention will become apparent to those skilled in the art upon review of the following detailed description, claims, and drawings, wherein like elements have like numerals throughout the drawings.

### BRIEF DESCRIPTION OF THE DRAWINGS

FIG. 1 is a perspective view of a display board assembly embodying the present invention.

FIG. 2 is a perspective section view taken along line 2-2 of FIG. 1.

FIG. 3 is a section view taken along line 3-3 of FIG. 1.

FIG. 4 is a section view similar to FIG. 3 showing an alternative embodiment of the invention.

FIG. 5 is a section view similar to FIG. 3 showing an alternative embodiment of the invention.

FIG. 6 is a section view similar to FIG. 3 showing an alternative embodiment of the invention.

FIG. 7 is a section view similar to FIG. 3 showing an alternative embodiment of the invention.

FIG. 8 is a section view similar to FIG. 3 showing an alternative embodiment of the invention.

FIG. 9 is a front elevational view of an alternative display board assembly embodying the invention.

FIG. 10 is an exploded perspective view of the display board assembly shown in FIG. 9.

FIG. 11 is a section view taken along line 11-11 of FIG. 9.

FIG. 12 is a section view taken along line 12-12 of FIG. 9.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including”, “having”, and “comprising” and variations thereof herein is meant to encompass the items listed thereafter and equivalents thereof as well as additional items. Furthermore, the use of“front,” “rear,” “top,” “bottom,” “side,” “upper,” “lower,” and the like is meant to describe elements as they relate to one another, but is in no way meant to recite specific orientations of the apparatus or specify how the invention described herein will be used, mounted, displayed, or positioned in use.

### DETAILED DESCRIPTION

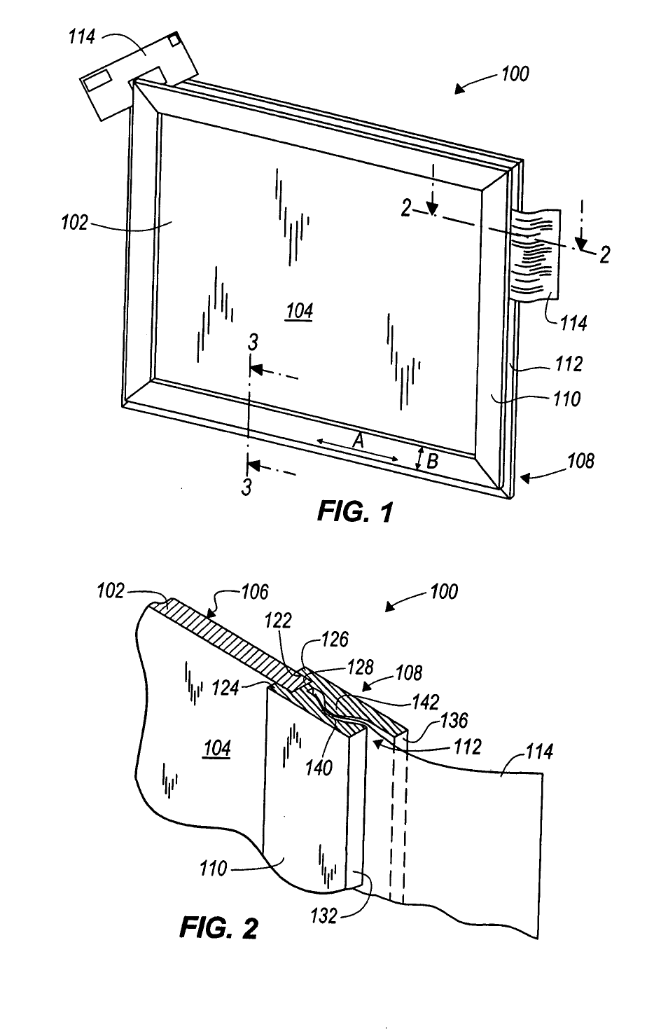

FIGS. 1-3 illustrate a display board assembly 100 embodying the present invention. The display board assembly 100 generally includes a display board 102 having a front display surface 104 and a rear surface 106 (see FIG. 2), and a frame 108 having a body 110 that defines a gap 112 dimensioned to receive and hold a sheet 114. As shown in FIG. 1, the gap 112 can extend along the entire periphery of the frame 108 and can therefore receive and hold a plurality of sheets 114 in the top, bottom, sides and corners of the frame 108. It is to be understood that the term “gap” as used herein and in the appended claims is in no way meant to be limiting. That is, the gap 112 can instead be referred to as a groove, channel, conduit, space, aperture, depression, recess, and the like, but will be referred to as a “gap” herein for simplicity and consistency.

As used herein and in the appended claims, the term “sheet” can refer to, but is not limited to, paper, cardboard, postcard, photograph, greeting card, brochure, envelope, and a combination thereof. A variety of shapes and sizes of sheets 114 of many lengths, widths and thicknesses can be received and held by the gap 112 of the present invention. Furthermore, a “sheet” can refer to a piece of paper that has been folded and not only single-sheet material. For example, a “sheet” can refer to newspapers, magazines, and other groups of flat media comprising several individual sheets.

As used herein and in the appended claims, the term “display board” can refer to a variety of display boards including, but not limited to, a dry erase board, marker board, bulletin board, magnetic board, chalk board, and a combination thereof. Any shape, size, and color of display board 102 can be used, and any or all sides of the display board can include a display surface. Accordingly, any shape and size of frame 108 can be used with the present invention, and the shape and size of the frame 108 does not need to correspond to the shape and size of the display board 102. Furthermore, the display board 102 can be formed of a variety of materials including, but not limited to, UV-coated chip board, wood, vinyl, plastic, and a combination thereof.

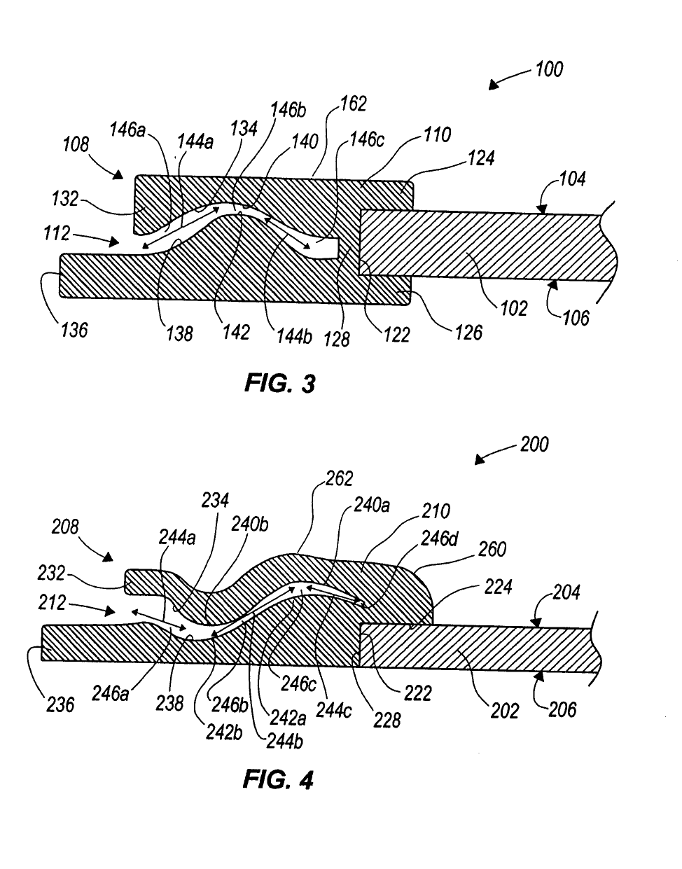

The frame 108 will be described herein as engageable with the display board 102, but it should be understood that the frame 108 need not be a separate element but can alternatively be integrally formed with the display board 102. The body 11O can have a variety of cross-sectional shapes. As illustrated in FIG. 3, the cross-sectional shape of the illustrated body 110 is generally an elongate, stepped (or bilayered) rectangle. The body 110 is generally rigid and defines a longitudinal direction and a transverse direction substantially perpendicular to the longitudinal direction. The longitudinal direction is generally illustrated in FIG. 1 as A, which is generally parallel with the periphery of the frame 108, and the transverse direction is generally illustrated in FIG. 1 as B, which is generally perpendicular to the periphery of the frame 108.

As best illustrated in FIGS. 2 and 3, the body 110 includes an aperture 122 dimensioned to receive at least a portion of the display board 102. The illustrated aperture 122 is generally U-shaped and is defined by a first side 124, a second side 126 and a bottom 128 connecting the first and second sides 124, 126. In the embodiment shown in FIGS. 1-3, the first side 124 is the same size as the second side 126. Alternatively, one of the sides 124, 126 can be longer than the other. At least a portion of the display board 102 is secured within the aperture 122 with any of a variety of fasteners known to those of ordinary skill in the art including, but not limited to, screws, pins, bolts, nails, adhesives, and the like. Alternatively, the aperture 122 can include a tongue-and-groove connection with the display board 102 such that the display board 102 is snap-fit into the aperture 122.

As best illustrated in FIGS. 2 and 3, the body 110 has a first projection 132 that defines a first surface 134, and a second projection 136 that defines a second surface 138 positioned to face the first surface 134. The first surface 134 and the second surface 138 define the gap 112. The first and second projections 132, 136 are substantially rigid such that the gap 112 is dimensioned to receive and hold a sheet 114 without using clamps, clips, pins or other movable or removable devices. The first projection 132 is shown in FIGS. 1-3 as being shorter than the second projection 136, but this is not necessary. By shortening the first projection 132 with respect to the second projection 136, a sheet 114 can be at least partially supported by the second projection 136 while still being visible from the front of the display board assembly 100. The first and second projections 132, 136 can alternatively be the same length, or the second projection 136 can be shorter than the first projection 132.

The illustrated gap 112 has a generally U-shaped cross-section, as best shown in FIG. 3. The shape of the gap 112 changes with respect to the transverse direction of the body 110 but does not substantially change with respect to the longitudinal direction of the body 110. The first surface 134 is at least partially defined by a longitudinally-extending groove 140 having a generally curved cross-section. The second surface 138 is at least partially defined by a longitudinally-extending protrusion 142 that also has a generally curved cross-section. The longitudinally-extending groove 140 and protrusion 142 thereby define a gap 112 having a generally uniform shape in the longitudinal direction and a varied shape in the transverse direction. The resulting gap 112, in cross-section, goes through a first distance 144a in generally a first direction and a second distance 144b in generally a second direction, which is different from the first direction. It is believed that this change in direction of the gap facilitates engagement of a sheet.

The first and second surfaces 134, 138 can be substantially parallel with one another to define a gap 112 of uniform thickness, or the first and second surfaces 134, 138 can be non-parallel to define a gap 112 of varying thickness. Particularly, although the longitudinally-extending groove 140 and the longitudinally-extending protrusion 142 may have corresponding curved shapes, they do not need to be parallel at all points of the gap 112 along the transverse direction. That is, the thickness of the gap 112 can change in the transverse direction. The illustrated gap 112 includes a first relatively thick portion 146a that forms a mouth or opening for facilitating inserting a sheet 114 into the gap 112. The gap 112 further includes a second relatively thin portion 146b to inhibit movement of the sheet 114 while in the gap 112 and improve holding capabilities of the gap 112. A third relatively thick portion 146c allows an end of the sheet 114 to move further into the gap 112 without binding or crinkling. The thicknesses of these portions 146a, 146b, 146c are at least partially determined by the type of sheets 114 that will be inserted into the gap 112. The thickness of the gap 112 is generally tight enough to hold a sheet 114 in a secure position but loose enough to allow quick and facile removal of the sheet 114 from the gap 112, and to a stack of sheets to be inserted.

A sheet 114 can be posted to the display board assembly 100 by inserting the sheet 114 into the gap 112. When the sheet 114 is inserted into the gap 112, a first edge of the sheet 114 is moved a first distance in a first direction (corresponding generally to the first distance 144a) and a second distance in a second direction (corresponding generally to the second distance 144b). That is, the sheet 114 can be inserted into the gap 112 by moving the sheet 114 into and along the gap 112 substantially along the transverse direction, thereby moving the sheet 114 through a varied path such that the sheet 114 is substantially prevented from falling out of the gap 112 until sufficient force is applied to remove the sheet 114 from the gap 112. To remove the sheet 114 from the gap 112, the sheet 114 can be moved generally along the longitudinal direction, the transverse direction, or a combination of both. Because the sheet 114 is not clamped or clipped into the frame 108, the sheet 114 can be removed by merely sliding the sheet 114 from the gap 112 in any direction necessary.

The body 110 of the frame 108 can be formed of a variety of materials including, but not limited to, wood, polystyrene, plastic, vinyl, aluminum, Melamine hard board, UV-coated tile board, and a combination thereof. The portion of the body 110 that defines the aperture 122 can be formed of the same or a different material that makes up the first and second projections 132, 136. Additionally, the first and second projections 132, 136 can be formed of the same or a different material. In the illustrated embodiment, the first projection 132 is formed of a translucent material to allow data (e.g., at least one of a picture, message, drawing, and the like) on a sheet 114 inserted in the gap 112 to be viewed through the first projection 132. Any portion of the frame 108 can be formed of a translucent material.

FIG. 4 illustrates a second embodiment of the present invention. The illustrated display board assembly 200 comprises a display board 202 and frame 208. The frame body 210 comprises an aperture 222 dimensioned to receive at least a portion of the display board 202. The aperture 222 of the second embodiment has generally an L-shape formed by a side 224 and a bottom 228. This generally L-shaped aperture 222 can engage at least a portion of the display board 202 by any commonly-known type of engagement, as discussed above. The display board 202 has a generally rectangular cross-section, and can therefore easily fit adjacent or within the aperture 222. The body 210 has a generally elongate, stepped (or bilayerd) rectangular cross-section, with a rounded corner 260 and a wavy, front-facing surface 262. The body 210 further comprises first and second projections 232, 236 defining first and second surfaces 234, 238, respectively, that define the gap 212. The first and second projections 232, 236 are substantially rigid, and the first projection 232 is shorter than the second projection 236.

The gap 212 of FIG. 4 has a generally S-shaped cross-section. The gap shape is defined by the first and second surfaces 234, 238 and changes with respect to the transverse direction of the body 210 but generally does not change with respect to the longitudinal direction of the body 210. The first surface 234 is at least partially defined by a longitudinally-extending groove 240a and a longitudinally-extending protrusion 240b adjacent the longitudinally-extending groove 240a. The combination of the longitudinally-extending groove and protrusion 240a, 240b defines a generally S-shaped first surface 234, as shown in FIG. 4. The first projection 232 is generally uniform in thickness and, therefore, the groove 240a and protrusion 240b also contribute to the appearance of the wavy, front-facing surface 262. The second surface 238 is at least partially defined by a longitudinally-extending protrusion 242a and a longitudinally-extending groove 242b adjacent the longitudinally-extending protrusion 242a. The combination of the protrusion 242a and the groove 242b has a generally S-shaped cross-section that generally corresponds to the S-shape of the first surface 234. The resulting gap 212, in cross-section, goes through a first distance 244a in a first direction, a second distance 244b in a second direction, and a third distance 244c in a third direction.

The gap 212 includes a first relatively thick portion 246a that forms a mouth or opening for facilitating inserting a sheet 114 into the gap 212. The gap 212 further includes a second relatively thin portion 246b for securing the sheet 114 in the gap 212, a third relatively thick portion 246c to better accommodate an end of the sheet 114 as it is moved further into the gap 212, and a fourth relatively thin portion 246d that provides improved holding capabilities for holding the sheet 114 within the gap 212. The thicknesses of the portions 246a, 246b, 246c, 246d are at least partially determined by the type of sheets 114 that will be inserted into the gap 212. Although capable of receiving and holding any type of sheet 114, as discussed above, the gap 212 is particularly useful for holding single sheets of paper, providing a relatively tortuous path to ensure that a sheet 114 is properly secured within the gap 212.

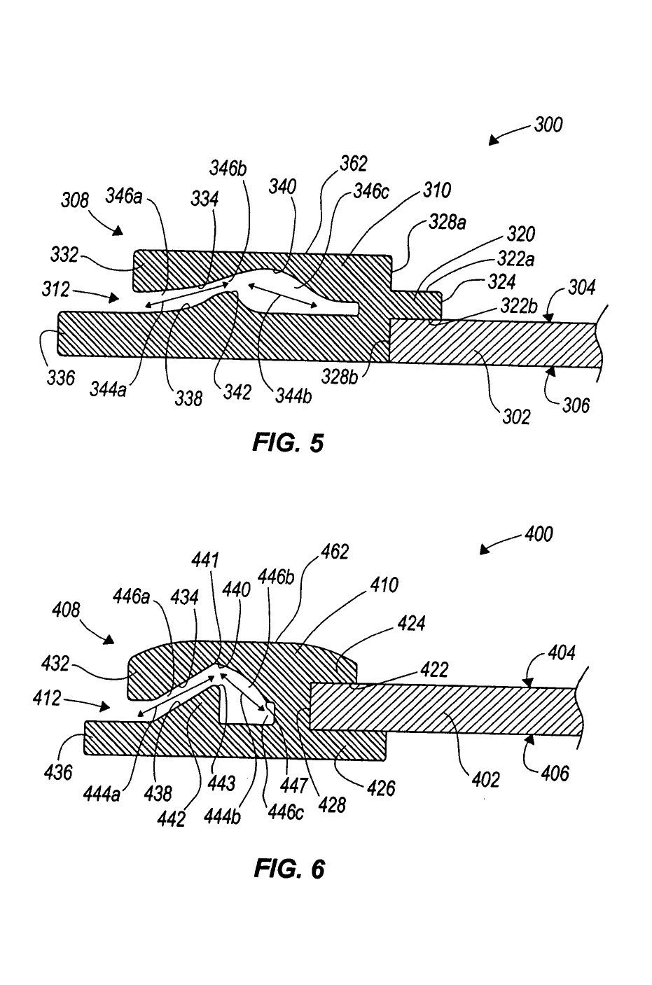

FIG. 5 illustrates a third embodiment of the present invention. The illustrated display board assembly 300 comprises a display board 302 and frame 308. The frame body 310 comprises a generally T-shaped portion 320 that defines two generally L-shaped apertures 322a, 322b, at least one of which is dimensioned to receive at least a portion of the display board 302. The apertures 322a, 322b are each formed by a side 324 and a bottom 328a or 328b, respectively. Either of these generally L-shaped apertures 322a, 322b can engage at least a portion of the display board 302 by any commonly-known type of engagement, as discussed above. Alternatively, the display board 302 can comprise a mating U-shaped portion (not shown) that would mate with the T-shaped portion 320. The display board 302 has a generally rectangular cross-section and can therefore easily fit adjacent or within either aperture 322a or 322b. In FIG. 5, the display board 302 is shown engaged with the rear aperture 322b, which allows the side 324 to act as a mat for the display board 302 and frame 308, thereby enhancing the aesthetics of the display board assembly 300.

The body 310 further comprises first and second projections 332, 336 defining first and second surfaces 334, 338, respectively, that define the gap 312. The first and second projections 332, 336 are substantially rigid. The first projection 332 is shown in FIG. 5 as being shorter than the second projection 336.

The gap 312 has a varying cross-sectional shape, as shown in FIG. 5. The gap shape is defined by the first and second surfaces 334, 338 and changes with respect to the transverse direction of the body 310 but generally does not change with respect to the longitudinal direction of the body 310. The first surface 334 is at least partially defined by a longitudinally-extending groove 340 having a generally curved cross-section. The second surface 338 is at least partially defined by a longitudinally-extending protrusion 342 that also has a generally curved cross-section. The longitudinally-extending groove 340 and longitudinally-extending protrusion 342 thereby define a gap 312 having a generally uniform shape in the longitudinal direction and a varied shape in the transverse direction. FIG. 5 shows a transverse cross-section of the display board assembly 300, and shows the gap 312 as having a varied cross-sectional shape. The gap 312, in cross-section, goes through a first distance344a in generally a first direction and a second distance 344b in generally a second direction. The longitudinally-extending groove and protrusion 340, 342 are substantially different sizes and shapes. That is, the longitudinally-extending groove 340 is larger than the longitudinally extending protrusion 342 and has a maximum point positioned closer to the display board 302 than the longitudinally extending protrusion 342.

FIG. 6 illustrates a fourth embodiment of the present invention. The illustrated display board assembly 400 comprises a display board 402 and frame 408. The frame includes a body 410 having a generally U-shaped aperture 422 dimensioned to receive at least a portion of the display board 402. The aperture 422 is formed by a first side 424, a second side 426, and a bottom 428 connecting the first and second sides 424, 426. The display board 402 has a generally rectangular cross-section, similar to the display boards discussed above, and can therefore easily fit adjacent or within the aperture 422. In FIG. 6, the first side 424 is shorter than the second side 426.

The gap 412 has a generally hook-shaped cross-section, as shown in FIG. 6. The gap shape is defined by the first and second surfaces 434, 438 and changes with respect to the transverse direction of the body 410 but generally does not change with respect to the longitudinal direction of the body 410. The first surface 434 is at least partially defined by a longitudinally-extending groove 440 having a generally rounded triangular cross-section. The second surface 438 is at least partially defined by a longitudinally-extending protrusion 442 that also has a generally triangular cross-section. The gap 412, in cross-section, goes through a first distance 444a in generally a first direction and a second distance 444b in generally a second direction. The longitudinally-extending groove 440 has an apex 441 and is generally longer and rounder than the longitudinally-extending protrusion 442. The longitudinally-extending protrusion 442 is an asymmetrical, right triangle with a vertex 443 positioned at approximately the same point along the gap 412 as the apex 441 of the generally triangular, longitudinally-extending groove 140.

The gap 412 includes a first portion 446a that is generally uniform in thickness and that extends from a mouth portion of the gap 412 to a position adjacent the apex 441 and the vertex 443. The gap 412 further includes a second portion 446b that is thickest adjacent the first portion 446a and that generally decreases in thickness to a third portion 446c that generally begins after a small protrusion 447 from the first surface 432. The third portion 446c has a relatively uniform thickness, thereby providing a generally hook-shaped cross-section. The thicknesses of these portions 446a, 446b, 446c can correspond to the types of sheets 114 to be inserted into the gap 412, as discussed above.

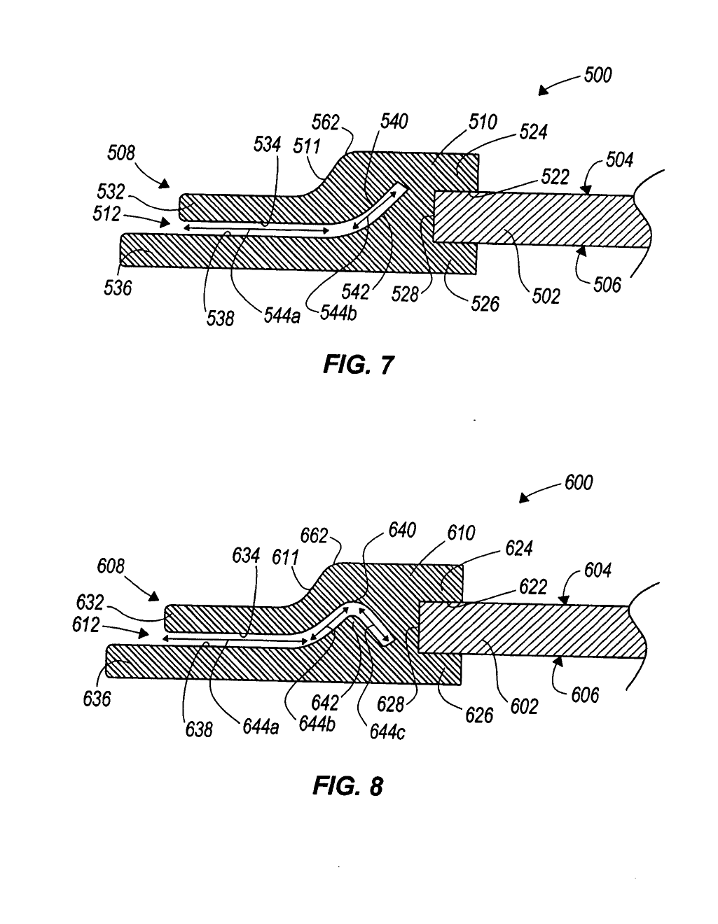

FIG. 7 illustrates a fifth embodiment of the present invention. The illustrated display board assembly 500 comprises a display board 502 and a frame 508 having a body 510 with a step 511. The body 510 is generally rigid and comprises first and second projections 532, 536 that define first and second surfaces 534, 538, that in turn define the gap 512. Since these elements are essentially similar to that described above regarding the display board assembly of FIG. 3, these elements will not be discussed in greater detail herein.

The gap 512, however, has a simple shape compared to the embodiments discussed above. The gap 512 has a generally J-shaped, uniformly thick cross-section. The first surface 534 is at least partially defined by a longitudinally-extending protrusion 540 having a slightly curved cross-section. The second surface 538 is at least partially defined by a longitudinally-extending groove 542 that also has a slightly curved cross-section. The longitudinally-extending protrusion 540 and groove 542 thereby define a gap 512 having a generally uniform shape in the longitudinal direction and a varied shape in the transverse direction. The gap 512, in cross-section, goes through a first distance 544a in generally a first direction and a second distance 544b in generally a second direction

FIG. 8 illustrates a sixth embodiment of the present invention. The illustrated display board assembly 600 comprises a display board 602 and a frame 608 having a body 610. The body 610 includes the aperture 622 and has a generally similar shape to that of body 510 of the display board assembly 500 in FIG. 7 (including the step 611 in the front-facing surface 662). Since these elements are essentially similar to that described above regarding the display board assembly 500, these elements will not be discussed in greater detail herein.

The gap 612 has a uniformly thick cross-section and has a similar shape to that of the gap 512 of FIG. 7, except that the gap 612 includes an additional portion 644c. The first surface 634 is at least partially defined by a longitudinally-extending groove 640 having a generally curved cross-section. The second surface 638 is at least partially defined by a longitudinally-extending protrusion 642 that also has a generally curved cross-section. The longitudinally-extending groove 640 and longitudinally-extending protrusion 642 define the gap 612 having a generally uniform shape in the longitudinal direction and a varied shape in the transverse direction. The gap 612, in cross-section, goes through a first distance 644a in generally a first direction, a second distance 644b in generally a second direction, and a third distance 644c in generally a third direction. The gap 612 therefore defines a more tortuous path than that of the gap 512 of FIG. 7 and may provide additional holding capabilities for retaining a sheet 114. As described above, the thickness of the gap 512 will depend at least in part on what type of sheets 114 will be inserted into the gap 512. Sheets 114 can be inserted and removed from the gap 512 in a manner similar to that discussed above regarding sheet 114 and gap 112.

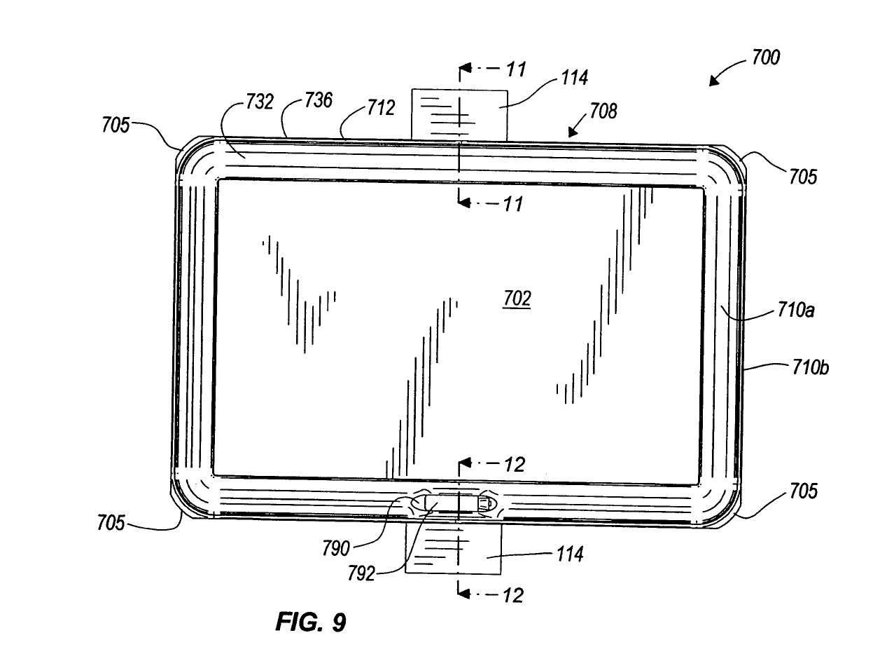

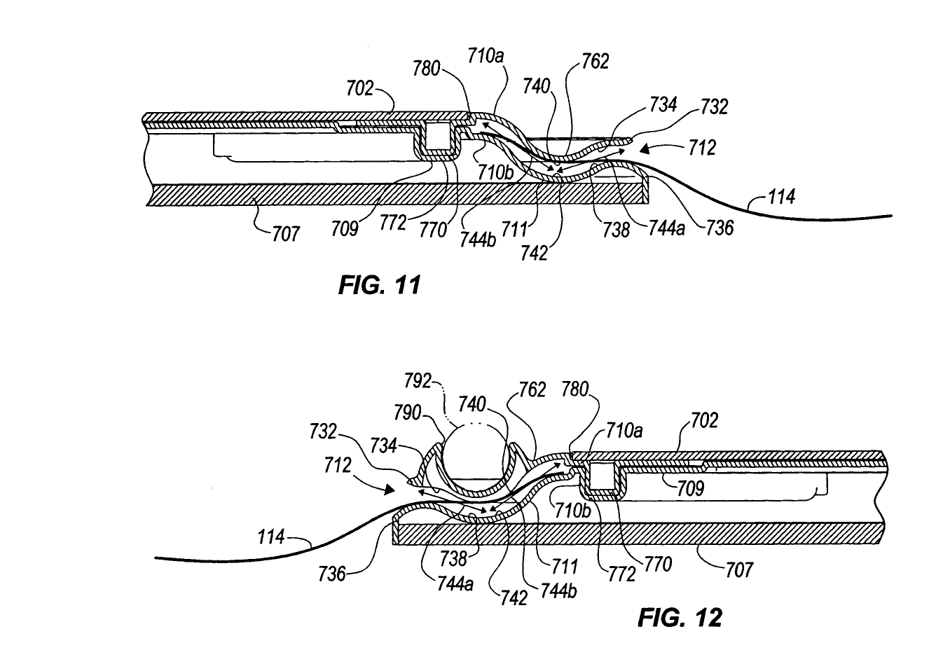

FIGS. 9-12 illustrate another display board assembly 700 embodying the present invention. The display board assembly 700 comprises a display board 702, a frame 708, and a rear panel 707. As with the embodiments discussed above, the frame 708 comprises a substantially rigid body 710 defining a longitudinal and transverse direction. The body 710 comprises a first portion 710a and a second portion 710b. The first and second body portions 710a, 710b are substantially rigid and are engageable with one another at one portion and are separated by a gap 712 at another portion, as best shown in FIGS. 11 and 12. Particularly, in the embodiment illustrated in FIGS. 9-12, the first and second portions 710a, 710b are engageable along an inner periphery (see FIG. 9) and separated by the gap 712 along an outer periphery. The first and second portions 710a, 710b comprise the first and second projections 732, 736, respectively. Similar to the embodiments described above, the first and second projections 732, 736 define first and second surfaces 734, 738, which define the gap 712. As with the embodiments discussed above, the first projection 732 is shorter (in cross-section, see FIGS. 11 and 12) than the second projection 736. Similar to some of the embodiments described above, the first projection 732 also includes a grooved or wavy front-facing surface 762 (see FIG. 11).

The first portion 710a is generally rectangularly-shaped with rounded corners and snaps into engagement with the second portion 710b, which is also generally rectangularly-shaped with beveled corners 705. The first and second portions 710a, 710b can be coupled together by a variety of conventional means including, but not limited to, nails, pins, screws, bolts, adhesive, a snap-fit engagement, a press-fit engagement, and a combination thereof. In the embodiment illustrated in FIGS. 9-12, the first and second portions 710a, 710b are coupled together in a snap-fit engagement between a series of rearwardly-projecting protrusions 770 from the first portion 710athat snap-fit into a series of forwardly-opening grooves 772 in the second portion 710b . As shown in FIG. 9, the protrusions 770 and the grooves 772 extend in the longitudinal direction of the body 710.

As best illustrated in FIGS. 11 and 12, the gap 712 has a generally U-shaped cross-section. The first surface 734 is at least partially defined by a longitudinally-extending protrusion 740 having a generally curved cross-section, and the second surface 738 is at least partially defined by a longitudinally-extending groove 742 having a generally curved cross-section. The gap 712, in cross-section, goes through a first distance 744a in generally a first direction and a second distance, 744b in generally a second direction.

The first and second surfaces 734, 738 are substantially parallel and define a gap 712 of substantially uniform thickness. Therefore, gap 712 does not necessarily include various portions of varying degrees of thickness, as described above with respect to some of the other display board assemblies. The thickness of the gap 712 will depend at least in part on what type of sheets 114 will be inserted into the gap 712. The gap 712 can alternatively be shaped like any of the gaps 112-612 discussed above, or can have any shape that would allow the frame 708 to receive and hold a sheet 114 without the use of any moving parts or devices.

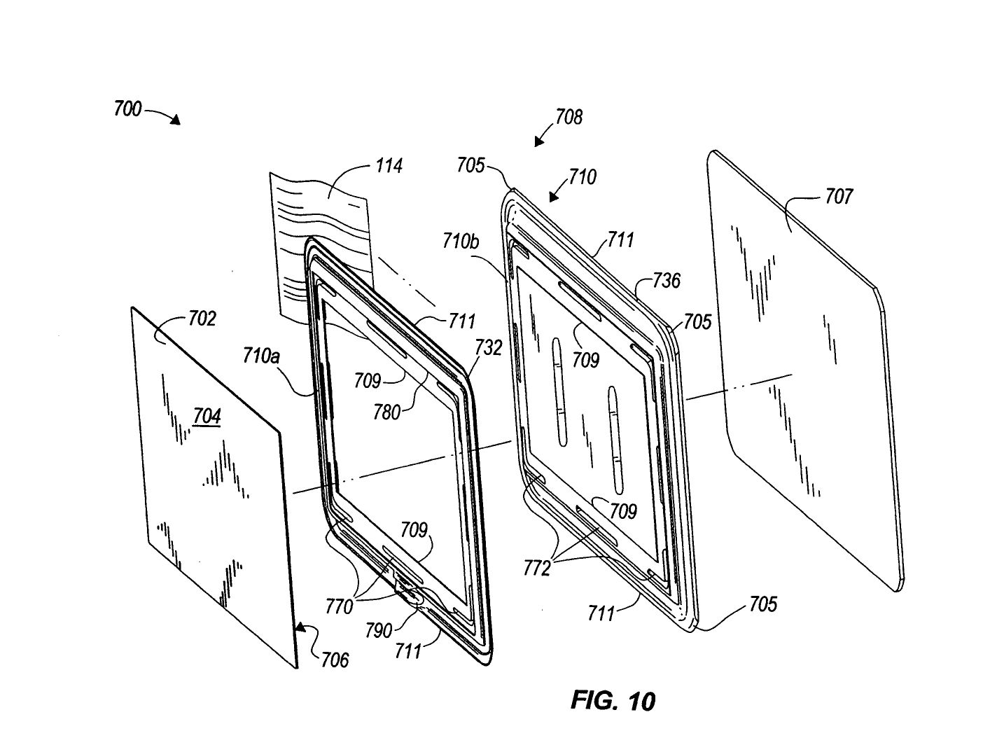

As illustrated in FIGS. 10-12, the display board 702 is engageable with the first portion 710a. Specifically, the first portion 710a includes a longitudinally-extending, forwardly-opening recess or aperture 780 dimensioned to receive at least a portion of the display board 702. At least a portion of the display board 702 can be coupled to the first portion 710a within the aperture 780 by any of a variety of conventional coupling means, including, but not limited to, nails, pins, screws, bolts, adhesive, a press-fit engagement, a snap-fit engagement, and the like.

As illustrated in FIGS. 9, 10 and 12, the frame 708 further comprises a receptacle 790 designed to receive and hold a writing implement 792. Specifically, in the embodiment illustrated in FIGS. 9, 10 and 12, the receptacle 790 is formed in a portion of the first projection 732. The receptacle 790 can have a variety of cross-sectional shapes to allow the receptacle 790 to receive a writing implement. The receptacle 790 is forwardly-opening and extends longitudinally along a center portion of the first projection 732 adjacent the bottom of the display board assembly 700. The receptacle 790 has a generally semi-circular cross-section and is resilient to allow generally cylindrical writing implements to be received within the receptacle 790. As shown in FIG. 12, the receptacle 790 is slightly more circular than semi-circular to better retain the writing implement 792 in the receptacle 790 in a snap-fit engagement. With continued reference to FIG. 12, the receptacle 790 protrudes slightly from the front-facing surface 762 instead of protruding rearwardly into the front-facing surface 762, thereby not interfering with the gap 712. Therefore, a sheet 114 can be inserted into the gap 712 along the entire periphery of the frame 708. That is, the portion of the frame 708 adjacent the receptacle 790 still defines at least a portion of the gap 712. The receptacle 790 can be shaped to accommodate any type of writing implement including, but not limited to, at least one of a dry erase marker, crayon, pen, pencil, paintbrush, marker, chalk, and a combination thereof. A receptacle such as the exemplary receptacle 790 can be used with any of the above-described display board assemblies 100-600 and is illustrated as a part of display board assembly 700 by way of example only.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiments described herein are further intended to explain best modes known for practicing the invention and to enable others skilled in the art to utilize the invention in such, or other, embodiments and with various modifications required by the particular applications or uses of the present invention.

1. A frame for a display board, the frame comprising:
a body engageable with the display board, the body having:
a first projection defining a first surface; and
a second projection defining a second surface positioned to face the first surface, wherein the first and second surfaces define a gap dimensioned to receive and hold a sheet.

2. The frame as set forth in claim 1, wherein at least one of the first projection and the second projection is formed of a translucent material.

3. The frame as set forth in claim 2, wherein the first projection defines at least part of a front of the frame and the second projection defines at least part of the rear of the frame, and wherein the first projection is formed of the translucent material.

4. The frame as set forth in claim 1, wherein the body comprises an aperture dimensioned to receive at least a portion of the display board.

5. The frame as set forth in claim 1, wherein the first and second projections are substantially rigid.

6. The frame as set forth in claim 1, wherein the first projection is shorter than the second projection.

7. The frame as set forth in claim 1, wherein the body of the frame defines a longitudinal direction and a transverse direction substantially perpendicular to the longitudinal direction, and wherein the gap comprises a shape that changes in the transverse direction.

8. The frame as set forth in claim 1, wherein the body of the frame defines a longitudinal direction, and wherein the gap is defined by at least one longitudinally-extending groove and at least one longitudinally-extending protrusion.

9. The frame as set forth in claim 8, wherein the at least one protrusion has a generally triangular cross-section.

10. The frame as set forth in claim 8, wherein the at least one protrusion has a generally curved cross-section.

11. The frame as set forth in claim 1, wherein the gap comprises a generally U-shaped cross-section.

12. The frame as set forth in claim 1, wherein the gap comprises a generally S-shaped cross-section.

13. The frame as set forth in claim 1, wherein the gap, in cross-section, comprises a first curve in a first direction and a second curve in a second direction, the second direction being different from the first direction.

14. The frame as set forth in claim 1, wherein the gap, in cross-section, goes through a first distance in a first direction and a second distance in a second direction, the second direction being different from the first direction.

15. The frame as set forth in claim 1, wherein the gap, in cross-section, comprises a first portion of increasing thickness, a second portion of decreasing thickness, and a third portion of increasing thickness.

16. The frame as set forth in claim 1, wherein the first surface is substantially parallel to the second surface.

17. The frame as set forth in claim 1, further comprising a receptacle positioned to removably receive a writing implement.

18. The frame as set forth in claim 17, wherein the receptacle is formed in the first projection.

19. A display board assembly comprising:
a display board; and
a frame coupled to the display board, the frame defining a gap dimensioned to receive and hold a sheet.

20. The display board assembly as set forth in claim 19, wherein the display board comprises at least one of a dry erase board, marker board, bulletin board, magnetic board, chalk board, and a combination thereof.

21. The display board assembly as set forth in claim 20, wherein the dry erase board comprises chipboard having a UV coating.

22. The display board assembly as set forth in claim 19, wherein the frame comprises a body having a first substantially rigid projection defining a first surface and a second substantially rigid projection defining a second surface positioned to face the first surface, and wherein the first and second surfaces define the gap therebetween.

23. The display board assembly as set forth in claim 22, wherein the first surface defines a protrusion and the second surface defines a groove.

24. The display board assembly as set forth in claim 22, wherein the first surface and the second surface are substantially parallel.

25. The display board assembly as set forth in claim 19, wherein the frame includes a body comprising a first portion and a second portion, the first and second portions being engageable at one end of the body and separated by the gap at an opposite end of the body.

26. The display board assembly as set forth in claim 19, wherein at least a portion of the frame is formed of a translucent material.

27. The display board assembly as set forth in claim 19, wherein the frame comprises an aperture, and wherein at least a portion of the display board is positioned in the aperture.

28. The display board assembly as set forth in claim 19, wherein the gap, in cross-section, has a first relatively thick portion, a second relatively thin portion and a third relatively thick portion.

29. The display board assembly as set forth in claim 19, wherein the frame defines a longitudinal direction, and wherein the gap is defined by at least one longitudinally-extending groove and at least one longitudinally-extending protrusion.

30. The display board assembly as set forth in claim 19, wherein the gap has a generally U-shaped cross-section.

31. The display board assembly as set forth in claim 19, wherein the gap has a generally S-shaped cross-section.

32. The display board assembly as set forth in claim 19, wherein the gap, in cross-section, goes through a first distance in a first direction and a second distance in a second direction, the second direction being different from the first direction.

33. The display board assembly as set forth in claim 19, wherein the frame comprises a receptacle positioned to removably receive a writing implement.

34. The display board assembly as set forth in claim 33, wherein a portion of the frame adjacent the receptacle defines at least a portion of the gap.

35. A method for posting a sheet to a display board assembly, the method comprising:
providing a display board;
providing a frame for the display board having a first projection and a second projection, the first and second projections defining a longitudinal direction and a transverse direction substantially perpendicular to the longitudinal direction;
defining a gap between the first projection and the second projection, the gap dimensioned to receive and hold a sheet; and
inserting a sheet into the gap substantially along the transverse direction.

36. The method as set forth in claim 35, wherein providing a frame for the display board includes providing a frame body comprising a first portion and a second portion, the first and second portions being engageable at one end of the body and separated by the gap at an opposite end of the frame body.

37. The method as set forth in claim 35, wherein the first projection defines a first surface and the second projection defines a second surface positioned to face the first surface, and wherein defining a gap includes defining a gap with the first and second surfaces.

38. The method as set forth in claim 35, wherein the first projection is translucent, and further comprising viewing data on the sheet through the translucent first projection.

39. The method as set forth in claim 35, further comprising removing the sheet from the gap generally along at least one of the longitudinal direction and the transverse direction.

40. The method as set forth in claim 35, wherein inserting a sheet into the gap includes moving a first edge of the sheet a first distance in a first direction and moving the first edge of the sheet a second distance in a second direction, the second direction being different from the first direction.

41. The method as set forth in claim 35, wherein inserting a sheet into the gap includes inserting a sheet into a generally U-shaped gap.

42. The method as set forth in claim 35, wherein inserting a sheet into the gap includes inserting a sheet into a generally S-shaped gap.

43. The method as set forth in claim 35, wherein inserting a sheet into the gap includes inserting a sheet generally transversely with respect to at least one longitudinally-extending protrusion and at least one longitudinally-extending groove.
